(19) United States
(12) Patent Application Publication
(10) Pub. No.: US 2024/0160570 A1
(43) Pub. Date: May 16, 2024

(54) MECHANISM TO IDENTIFY KEY SECTIONS OF IO PACKETS AND ITS USE FOR EFFICIENT IO CACHING

(71) Applicant: Intel Corporation, Santa Clara, CA (US)

(72) Inventors: George Leonard TKACHUK, Phoenix, AZ (US); Aneesh AGGARWAL, Portland, OR (US); Niall D. MCDONNELL, Limerick (IE); Youngsoo CHOI, Alameda, CA (US); Chitra NATARAJAN, Queens Village, NY (US); Prasad GHATIGAR, Shannon (IE); Shrikant M. SHAH, Chandler, AZ (US)

(21) Appl. No.: 17/988,626

(22) Filed: Nov. 16, 2022

(51) Int. Cl. G06F 12/0802

(52) U.S. Cl. CPC G06F 12/0802; G06F 2212/62

(57) ABSTRACT

Mechanisms to identify key sections of input-output (IO) packets and use for efficient IO caching and associated apparatus and methods. Data, such as packets, are received from an IO device coupled to an IO port on a processor including a cache domain including multiple caches, such as L1/L2 and L3 or Last Level Cache (LLC). The data are logically partitioned into cache lines and embedded logic on the processor is used to identify one or more important cache lines using a cache importance pattern. Cache lines that are identified as important are written to a cache or a first cache level, while unimportant cache lines are written to memory or a second cache level that is higher than the first cache level. Software running on one or more processor cores may be used to program cache importance patterns for one or more data types or transaction types.

### BACKGROUND INFORMATION

Current processors such as Central Processing Units (CPUs) treat an entire Input-Output (IO) packet as a single entity and the entire packet goes through the same hardware flow. For instance, when caching an IO packet, the CPUs either caches the entire packet or diverts the entire packet to the memory. However, in many applications, all the data in an IO packet may not be processed in the same manner. For instance, some workloads like routers operate on only the packet header while others like IPSec (Internet Protocol Security) work with the entire packet. Similarly, some intrusion detection systems may choose to process the header and some parts (but not all) of the payload. Furthermore, different IO devices connected to a single CPU may also have different portions of their packets processed. The portion or portions that are processed comprise key portions or sections. Treating the entire packet from all the IO devices in a similar fashion may result in inefficient utilization of the CPU's resources. For instance, caching the entire packet for the workload that operates only on some (key) portions of the packet results in unnecessary pollution of the cache.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a table including information pertaining to five transactions;

FIG. 2 is a block diagram illustrating selective components and logic for writing important cache lines to caches, according to one embodiment;

FIG. 3 is a diagram of a computer system including a cache hierarchy comprising L1 instruction and data caches, L2 caches, and L3 cache (LLC), and memory;

FIG. 4 is a schematic diagram illustrating an abstracted view of a memory coherency architecture employed by the platform, according to one embodiment;

FIG. 5 is a diagram of a cache hierarchy comprising L1 instruction and data caches, L2 caches, and L3 caches, and an L4 cache;

FIG. 6(A) is a diagram illustrating a KPS (Key Packet Sections) pattern employing single-bit encoding, along with an optional core identifier and KPS offset;

FIG. 6(B) is a diagram illustrating a KPS (Key Packet Sections) pattern employing multi-bit encoding, along with an optional core identifier and KPS offset;

FIG. 7 is a diagram of a transaction address;

FIG. 8 is a diagram of a transaction address and packet size;

FIG. 9 is a flowchart illustrating operations and logic for processing transactions, according to one embodiment;

FIG. 10 is a diagram illustrating a core identifier, KPS bits, and cache line data;

FIG. 11 is a block diagram of an exemplary IPU chip;

FIG. 12 illustrates an example computing system;

FIG. 13 illustrates a block diagram of an example processor and/or System on a Chip (SoC) that may have one or more cores and an integrated memory controller;

FIG. 14(A) is a block diagram illustrating both an example in-order pipeline and an example register renaming, out-of-order issue/execution pipeline according to examples;

FIG. 14(B) is a block diagram illustrating both an example in-order architecture core and an example register renaming, out-of-order issue/execution architecture core to be included in a processor according to examples;

FIG. 15 illustrates examples of execution unit(s) circuitry; and

FIG. 16 is a block diagram of a register architecture according to some examples.

### DETAILED DESCRIPTION

Embodiments of mechanisms to identify key sections of IO packets and use for efficient IO caching and associated apparatus and methods are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the teachings and principles disclosed herein, hardware-based means is provided in a processor that allows software executing on the processor's cores to specify the key sections of an IO packet and separate those key sections from the rest of the packet. Also proposed is a mechanism to cache the key sections of the packet in the lowest level cache supported by implementation, while diverting the rest of the packet to a higher-level cache or the memory for more efficient caching of IO data.

The hardware mechanism provides an easy way for customers (e.g., end users of computing platforms with the processors) to specify the portions of the IO data that are important for software applications and to separate out the key portions from the rest of the packet. This information is then used to cache only the key sections, while diverting the rest of the packet to a larger higher-level cache or the memory. The cache levels used to place the data will depend on the IO caching supported in the processor and can be made customer driven.

An embodiment exploits a key behavior observed in IO packets. Typically, IO packets are stored in pre-allocated network buffers which are of fixed size. Each network buffer stores one IO packet. When the packet enters the processor, it is broken down into cache line sized blocks. So, an IO packet data related to a prior packet can be identified by through detection of contiguous memory addresses, while the start of a new IO packet can be identified by having an address that is not contiguous to the address of the immediately previous packet. In one aspect, when a packet is received and broken into cache line sized blocks, the packet's data is seen in its entirety before the start of the next packet.

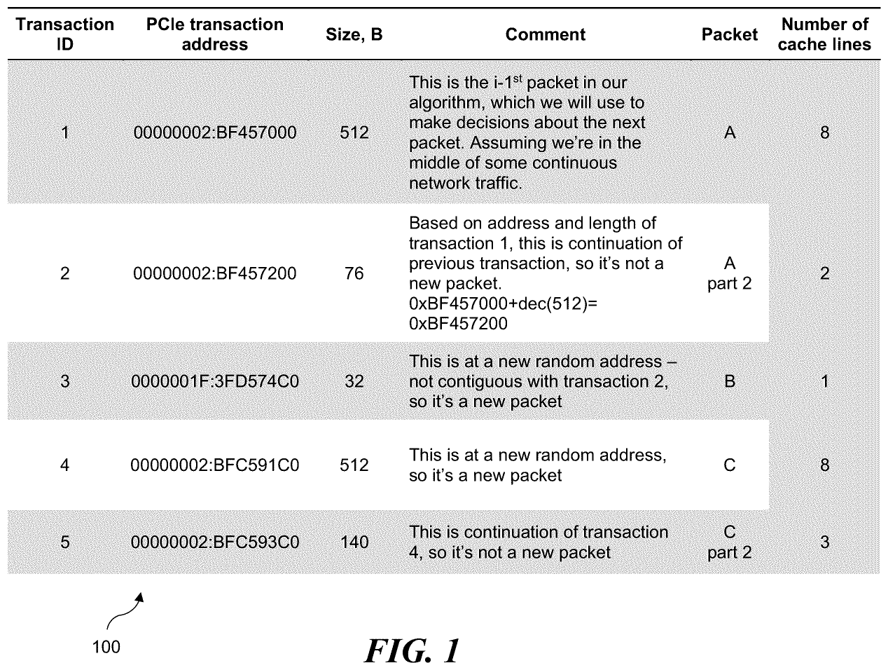

In one exemplary embodiment, the IO packets are PCIe (Peripheral Component Interconnect Express) packets. A Table 100 in FIG. 1 shows a PCIe trace for a networking workload demonstrating this behavior. Table 100 shows information for a sequence of 5 PCIe packets (as identified by a simplified Transaction ID), including a PCIe transaction address, a size in Bytes (B), a comment, a packet identifier, and the number of cache lines occupied by the packet. This example presumes that the packet sequence is in the middle of some continuous network traffic.

An i-1^{st} packet ‘A’ having a size of 512B is the first packet in the sequence and contains data that are stored in 8 cache lines. A common but not limiting size of a cache lines on modern CPUs is 64B (thus 512B occupies 8 cache lines). The next packet is ‘A part 2,’ which is 76B and is stored across 2 cache lines (e.g., 64B in a first cache line and 12B in a second cache line). As shown in the comment, based on the address and length of transaction 1, packet ‘A part 2’ is part of packet A and not a separate packet. This can be recognized by comparing the PCIe transactions addresses of transactions 1 and 2 and determining that,
0xBF457000+dec(512)=0xBF457200
   which matches the address of transaction 2. Another way to make this determination is to subtract the PCIe transaction address of the previous transaction (1 in this case) from the current PCIe transaction address and compare the difference to see if it matches the size of the previous transaction, e.g.,
0xBF457200−0xBF457000=dec(512)

Continuing at transaction 3, the address offset from transaction 2 is not 76B from the PCIe transaction address for transaction 2 and thus corresponds to a new random address, indicating transaction 3 is associated with a new packet ‘B.’ Likewise, transaction 4 is associated with a new packet ‘C’ having a new random address. For transaction 5, the offset of the PCIe transaction address is 512B, which matches the size of packet ‘C’; accordingly, transaction 5 is a continuation of transaction 4 and the associated packet is labeled ‘C part 2.’

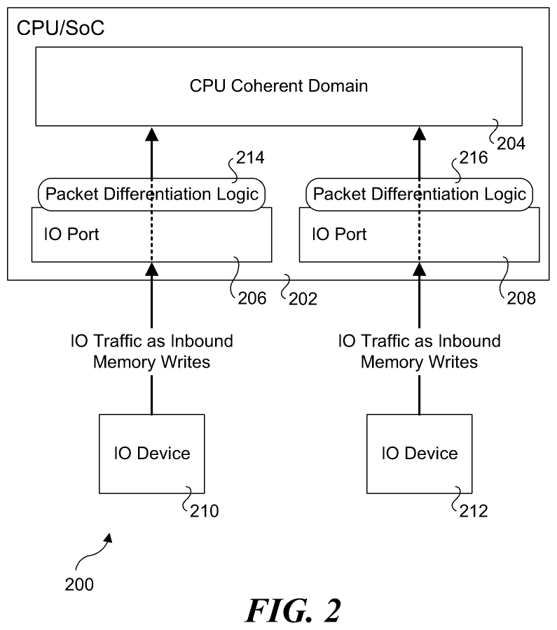

The hardware (called Packet Differentiation Logic (PDL)) to identify and separate the key sections of a packet is implemented in the IO port or along the path between an IO port and an interface to the CPU's coherent memory domain. In one embodiment, PDL is replicated for each of multiple IO ports. The IO port is a port where an IO device is connected, such as a PCIe Root Port (RP) or even a port for an integrated IP (Intellectual Property block) such as a crypto engine. PDL is located at a place where the entire IO packet is transferred in a serial fashion before any kind of reordering is done on the cache lines. This location could be right after the IO port or part of the IO port itself. For example, FIG. 2 shows such a location for a PCIe RP. Any IO device connected to the PCIe RP will send each IO packet serially.

In further detail, FIG. 2 shows an apparatus 200 including a CPU/SoC 202 having a System on Chip (SoC) architecture having a CPU coherent domain 204 and including a pair of IO ports 206 and 208 comprising PCIe RPs. IO port 206 is connected to an IO device 210 (e.g., a first PCIe endpoint device), while IO port 208 is connected to an IO device 212 (e.g., a second PCI endpoint device). Packet Differentiation Logic 214 is implemented in IP port 206 or otherwise between IO port 206 and CPU coherent domain 204. Likewise, Packet Differentiation Logic 216 is implemented in IP port 208 or between IO port 208 and CPU coherent domain 204.

IO devices 210 and 212 send IO traffic as inbound memory writes to their respective IO ports 206 and 208. For example, in the case of PCIe, IO devices may send PCIe Transaction Layer Packets (TLPs) containing destination memory addresses at which the TLP payload data are to be written.

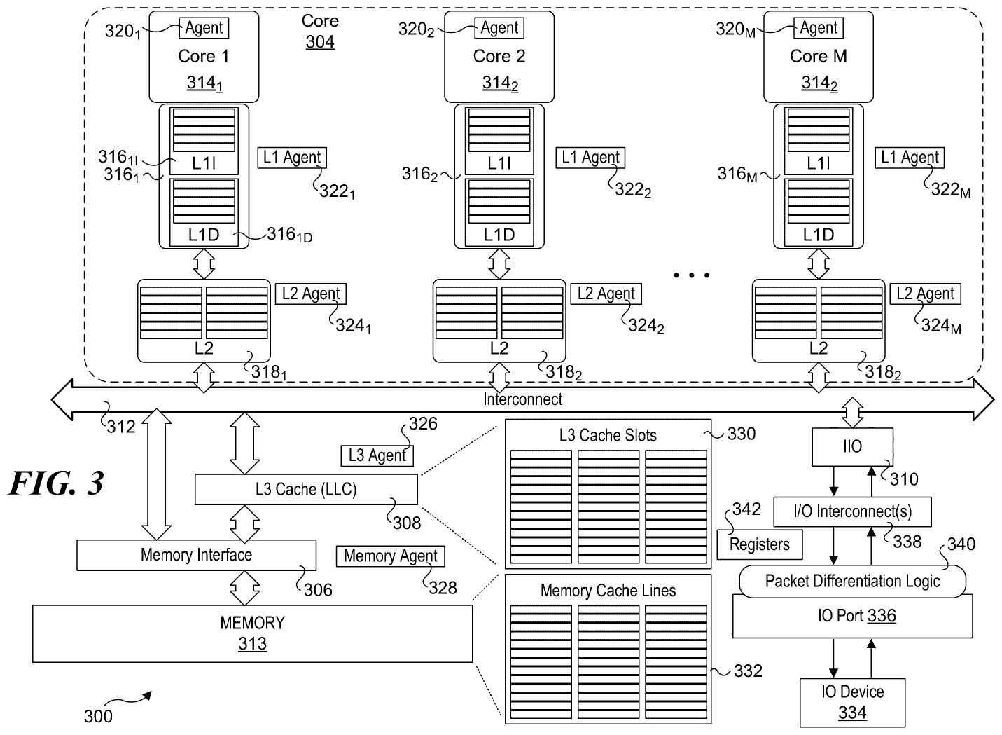

FIG. 3 shows selected hardware components of an exemplary computing platform 300. The hardware components include a CPU having a core 304 coupled to a memory interface 306, a last level cache (LLC) 308 and an integrated IO (IIO) controller 310 via an interconnect 312. In some embodiments, all or a portion of the foregoing components may be integrated on a System on a Chip (SoC). Memory interface 306 is configured to facilitate access to system memory 313, which will usually be separate from the SoC.

CPU core 304 includes M processor cores 314, each including a respective local level 1 (L1) cache 316 and a local level 2 (L2) cache 318 (the cores and the L1 and L2 caches 316 and 318 are depicted with subscripts indicating the core they are associated with, e.g., 316_{I} and 3181 for core 3141). Optionally, the L2 cache may be referred to as a “middle-level cache” (MLC). As illustrated in this cache architecture, an L1 cache 316 is split into an L1 instruction cache 3161 and an L1 data cache 316_{D} (e.g., 316u and 3161D for core 3141).

Computing platform 300 employs multiple agents that facilitate transfer of data between different levels of cache and memory. These including core agents 320, L1 agents 322, L2 agents 324, an L3 agent 326, and a memory agent 328. The L1, L2, and L3 agents are also used to effect one or more coherency protocols and to perform relating operations, such as snooping, marking cache line status, cache eviction, and memory writebacks. L3 agent 326 manages access to and use of L3 cache slots 330 (which are used to store respective cache lines). Data is also stored in memory 313 using memory cache lines 332.

For simplicity, interconnect 312 is shown as a single double-ended arrow representing a single interconnect structure; however, in practice, interconnect 312 is illustrative of one or more interconnect structures within a processor or SoC, and may comprise a hierarchy of interconnect segments or domains employing separate protocols and including applicable bridges for interfacing between the interconnect segments/domains. For example, the portion of an interconnect hierarchy to which memory and processor cores are connected may comprise a coherent memory domain employing a first protocol, while interconnects at a lower level in the hierarchy will generally be used for IO access and employ non-coherent domains. The interconnect structure on the processor or SoC may include any existing interconnect structure, such as buses and single or multi-lane serial point-to-point, ring, torus, or mesh interconnect structures (including arrays of rings or torus).

IIO controller 310 is used to manage traffic between the one or more IO domains and the coherent domain, which may also be referred to as a mesh domain for SoC architectures with core laid out in a grid. A non-limiting example of an IO domain is a PCIe domain, which may comprise a hierarchical structure including a PCIe root controller and one or more PCIe root ports. Other type of IO structure and protocols may also be supported, such as, but not limited to Advanced High performance Bus (AHB), Advanced Xtensible Bus (AXI), Compute Express Link (CXL), Non-volatile Memory Express (NVMe), Serial ATA (SATA), and Universal Serial Bus (USB). (CXL and NVMe operate over PCIe link structures.)

FIG. 3 further shows an IO device 334 coupled to an IO port 336 that is coupled to IIO controller 310 via IO interconnect(s) 338, which are representative of various types of IO link and bus structures that may differ with different types of IO ports. Like before, packet differentiation logic 340 is either implemented in IO port 336 or along the path between IO port 336 and IIO controller 310. Also depicted is a set of registers 342 whose use and operation are explained below.

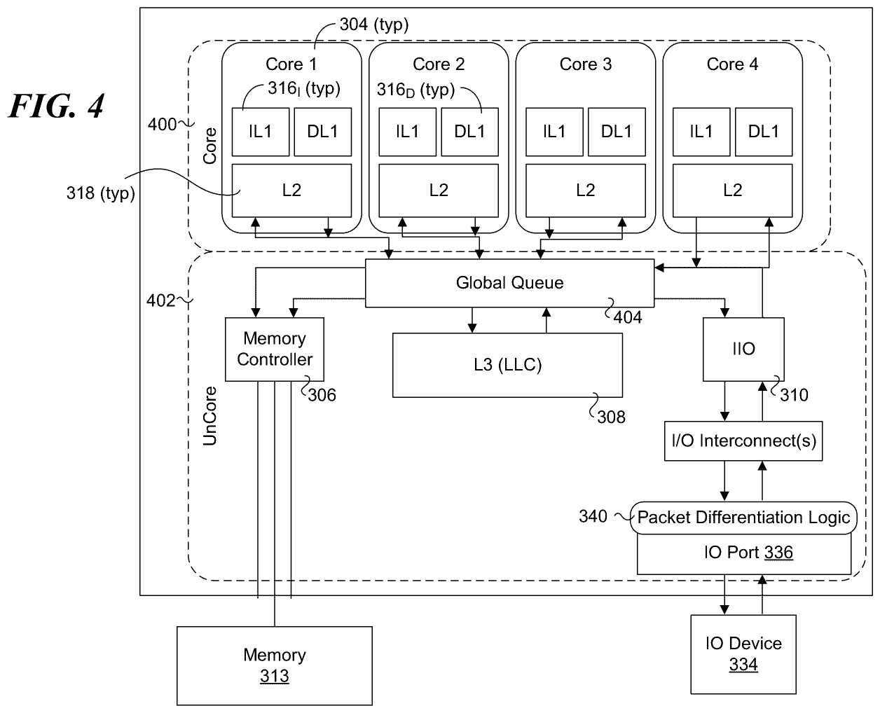

FIG. 4 shows an abstracted view of a memory coherency architecture employed by the embodiments of FIGS. 2 and 3. Under this and similar architectures, such as employed by some Intel® and AMD® processors, the L1 and L2 caches are part of a coherent memory domain under which memory coherency is managed by coherency mechanisms in the processor core 400. As in FIG. 3, each core 314 includes a L1 instruction (IL1) cache 316_{I}, and L1 data cache (DL1) 316_{D}, and an L2 cache 318. In some embodiments L2 caches 318 are non-inclusive, meaning they do not include copies of any cachelines in the L1 instruction and data caches for their respective cores. As an option, L2 may be inclusive of L1, or may be partially inclusive of L1. In addition, L3 may be inclusive of L1 and/or L2 or non-inclusive of L1/L2. Under another option, L1 and L2 may be replaced by a cache occupying a single level in cache hierarchy.

Meanwhile, the LLC is considered part of the “uncore” 402, wherein memory coherency is extended through coherency agents (e.g., L3 agent 326 and memory agent 328). As shown, uncore 402 (which represents the portion(s) of the SoC circuitry that is external to core 400) includes memory controller 306 coupled to external memory 313 and a global queue 404. Global queue 404 also is coupled to an L3 cache 308, and IIO controller 310.

As is well known, as you get further away from a core, the size of the cache levels increases, but so does the latency incurred in accessing cachelines in the caches. The L1 caches are the smallest (e.g., 32-64 KiloBytes (KB)), with L2 caches being somewhat larger (e.g., 256-640 KB), and LLCs being larger than the typical L2 cache by an order of magnitude or so (e.g., 8-16 MB). Of course, the size of these caches is dwarfed by the size of system memory (on the order of GigaBytes of even tens of GigaBytes). Generally, the size of a cacheline at a given level in a memory hierarchy is consistent across the memory hierarchy, and for simplicity and historical references, lines of memory in system memory are also referred to as cache lines even though they are not actually in a cache. It is further noted that the size of global queue 404 is generally quite small, as it is designed to only momentarily buffer cachelines that are being transferred between the various caches, memory controller 306, and an IIO controller 310.

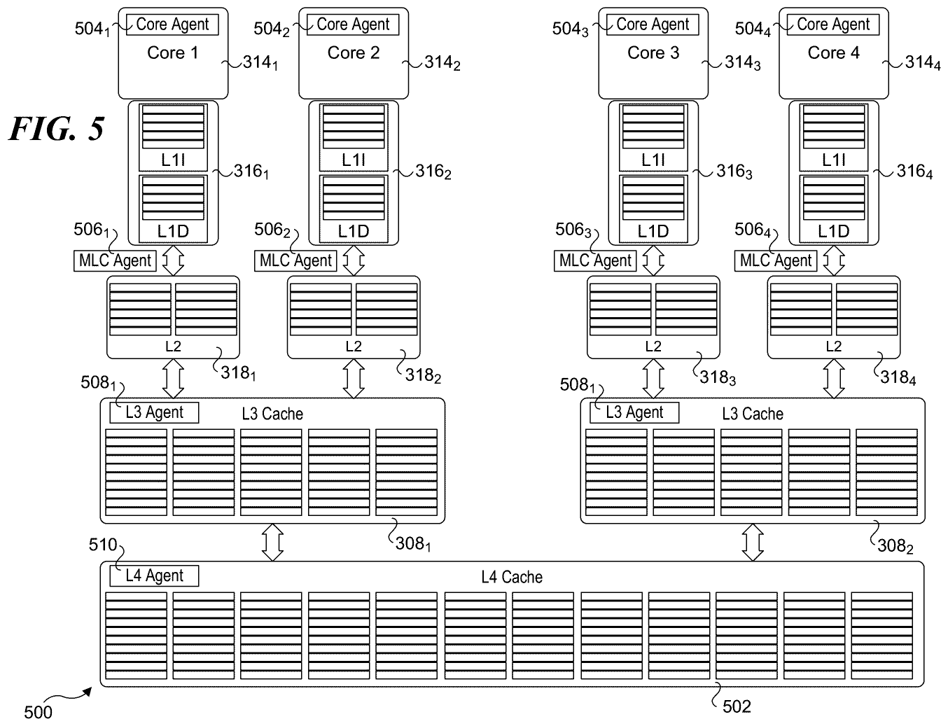

FIG. 5 shows a cache architecture 500 including an L4 cache 502. The core, L1, L2, and L3 caches in cache architecture 500 are similar to like-numbered components discussed above, and includes four cores 314 (also labeled Core 1, Core 2, Core 3, and Core 4), an L1 cache 316 for each core including a L1 instruction and L1 data cache, and an L2 cache 318 for each core. Generally, cache architecture 500 may include n cores, with an L3 cache dedicated to a given subset of the n cores. For example, if there are three L3 caches, each L3 cache may be dedicated to n/3 cores. In the illustrated non-limiting example, an L3 cache 308 is dedicated to a pair of cores.

Each core 314 includes a core agent 504 and has an associated MLC agent 506, and an L3 cache agent 508. L4 cache 502 includes an L4 cache agent 510. L4 cache 502 operates as the LLC for cache architecture 500 and is connected to system memory via a memory controller (both not shown).

As a variant of cache architecture 500, L4 cache 502 is operated as an IO cache. In addition, there may be a separate IO cache for each IO port or group of IO ports sharing a common protocol.

In one embodiment, a model specific register (MSR) (called Key Packet Sections (KPS)) is provided at each PDL 214 and 216 (of FIG. 2) and PDL 336 of FIG. 3 that is filled in by software executing on the CPU (core(s)) to indicate the key sections for a packet for associated transactions and/or transaction type. In a first embodiment, the KPS contains a 1:1 binary encoding where each bit of the KPS specifies whether a cache line is important: a ‘1’ suggests a key cache line and a ‘0’ suggests a not-so-important cache line. For instance, a value of 110100 suggests that the first two and the fourth cache lines are important.

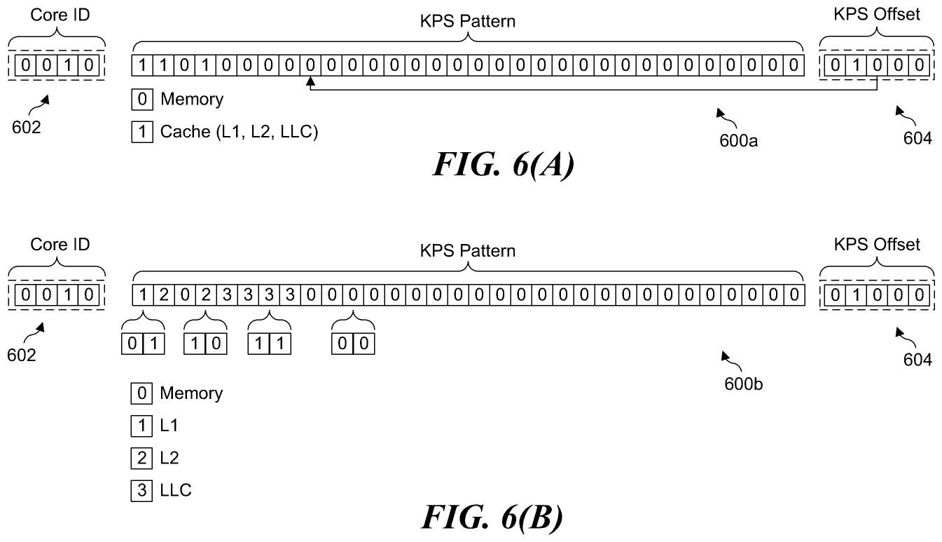

FIG. 6(A) depicts a 32-bit KPS register 600a containing an exemplary single-bit KPS pattern using a 1:1 binary encoding. In this embodiment, the size of KPS is 32 bits indicating that the largest packet size (or collective message size over multiple transactions) is 32 cache lines (e.g., 2048B for an architecture employing 64B cache lines, 4096B for an architecture employing 128B cache lines). If a packet (or message) is larger than the number of bits provided in KPS, then the rest of the packet could be cached or diverted to the memory or could follow the same flow as the last bit in the KPS.

FIG. 6(A) also shows an optional 4-bit core identifier (ID) 602 that may be stored in the same register as the KPS pattern or in a separate register. For instance, a 36-bit register could be used to store both, or a 32-bit register could be used with the KPS pattern comprising 28 bits. The number of bits in the core ID will depend on the number of cores in the CPU, processor, SoC, etc. 4-bit encoding supports up to 16 cores. In some embodiments the number of bits used for the core ID may exceed the minimum number of bits needed for a particular processor model or SKU (e.g., a 4-bit core ID could be used with a processor having 8 or less cores). As explained below, under an alternative approach, one or more snoop filters may be used to determine which cache(s) to write cache lines to.

Under a binary pattern, the cache line may be written to cache or memory, or different cache levels. In FIG. 6(A), a bit value of ‘1’ is written to a cache level (e.g., L1, L2, or LLC), while cache lines with a bit value of ‘0’ are written into memory. In the case of L1, L2, or LLC the PDL can employ a default value (e.g., on of L1, L2, or LLC), or there may be a separate register used to indicate which level of cache to write to.

Under an alternative implementation, a ‘1’ could indicate to write to an L1 or L2 cache, while a ‘0’ could indicate to write to an LLC.

In addition to binary KPS patterns, multi-bit KPS patterns may be used. For example, FIG. 6(B) show a multi-bit KPS pattern 600b comprising a 64-bit register in which two-bits are used to encode each cacheline importance value in the multi-bit KPS pattern. In this example the individual cacheline values are ‘0’ (Memory), ‘1’ (L1), ‘2’ (L2), and ‘3’ (LLC). If more than 4 levels are to be implemented, than an additional bit may be used. For instance, a KPS pattern that supports Memory, L1, L2, L3, and LLC (or an IO cache) will require 3 bits per cacheline.

KPS can be set to a default value on bring-up (e.g., during boot), and/or may be dynamically programmed by software during run-time. In addition to the registers and KPS patterns illustrated in FIGS. 6(A) and 6(B), there may be multiple instances of these data structures that may apply to different transaction types or transactions that are directed to different processor cores (to be consumed by software executing on the different processor cores).

A means is also provided to handle packets or messages that span multiple transactions. For example, for some protocols a transaction has a maximum size, while the data unit to be written (a packet, message, or other type of data unit) may be larger than the maximum size and thus span two or more transactions. Under this condition, the data spanning the multiple transactions are to be written to contiguous cache line addresses. Following sections describe schemes for handling this under which a determination is made to whether a given transaction corresponds to a new data unit (e.g., new packet or message) or contains data that is a subsequent part of a prior transaction (or transactions).

In one embodiment, a register (called Packet Address (PA)) is provided to store the address of the latest cache line written by the IO agent or PDL. In cases, where multiple contiguous cache lines are written by the IO agent, the PA register stores the address of the last cache line in that bunch. Each new cache line's address is compared with the address in PA. If the new cache line is non-contiguous to the PA address, then a new packet or message is identified and the first bit in KPS indicates whether the cache line is important or not. The importance of each subsequent cache line in the packet (identified by contiguous addresses) is determined by the following bits in KPS. Thus, the key sections of a packet can be identified and separated from the rest of the packet.

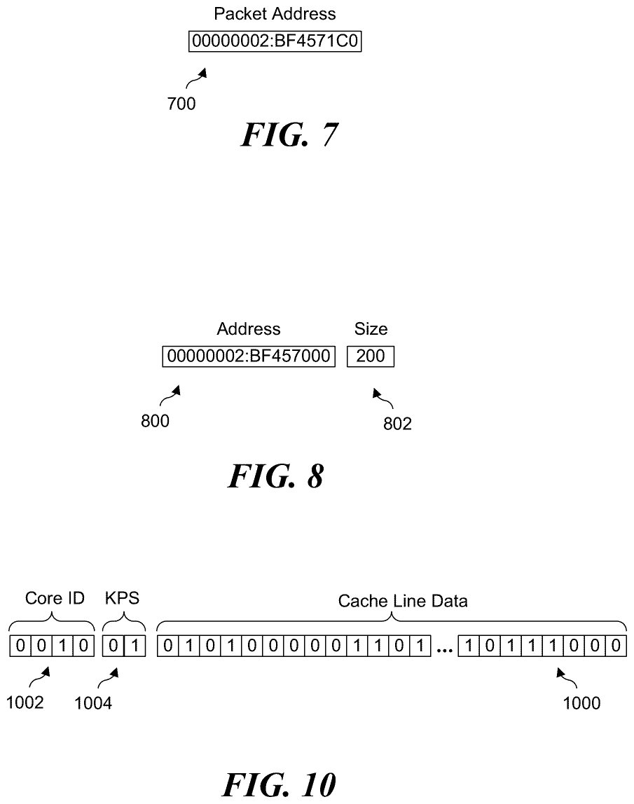

An example of a PA register 700 is shown in FIG. 7. In this example, hex encoding is shown for ease of understanding. The value shown (00000002:BF4571C0) corresponds to the last cache line written from for transaction ID 1 in table 100 of FIG. 1.

Under a second embodiment, continuity of the data in successive transactions is determined using the cache line addresses of the transactions, along with the size of a prior transaction. An example of a PA register 800 and size register 802 configured for this approach is shown in FIG. 8. Generally, a transaction, such as a memory write or returned memory read, includes a transaction address corresponding to the address of the first cacheline at which the start of the transaction payload data are to be written, along with a size of the payload data. Accordingly, if the address of a second transaction is equal to the address of a first transaction+the size of the first transaction then the data are contiguous and part of the same packet, message, or other type of data unit.

In one embodiment, in addition to a KPS register a register is used to track the current offset in the KPS pattern (called the KPS offset). This register may be a separate register, the same register used to store the core ID, or a single register may be used to store the core ID, KPS pattern, the KPS offset.

In other embodiments a KPS flag can be used to indicate how data are to be handled for transactions containing contiguous data with prior transactions. For example, for some types of transactions, latter portions of payload data will not contain important data. Accordingly, a flag could be used to indicate that any contiguous data in a subsequent transaction will be written to a default cache level or memory.

Returning to FIGS. 6(A) and 6(B), each of these figures further show KPS offset register 604. In one embodiment, the KPS offset register is used to track the current cache line offset location for cases in which contiguous data is contained in a subsequent transaction os transactions. As each transaction is processed, the KPS offset is advanced by the number of cachelines contained in the transaction (e.g., size of payload data divided by cacheline size). Optionally, the KPS offset position may be incremented with each cache line forwarded by the IO. When it is determined a transaction contains a new packet, message or other data unit, the KPS offset is reset to 0 (e.g., ‘00000’ in this example) to return the offset to the start of the KPS pattern.

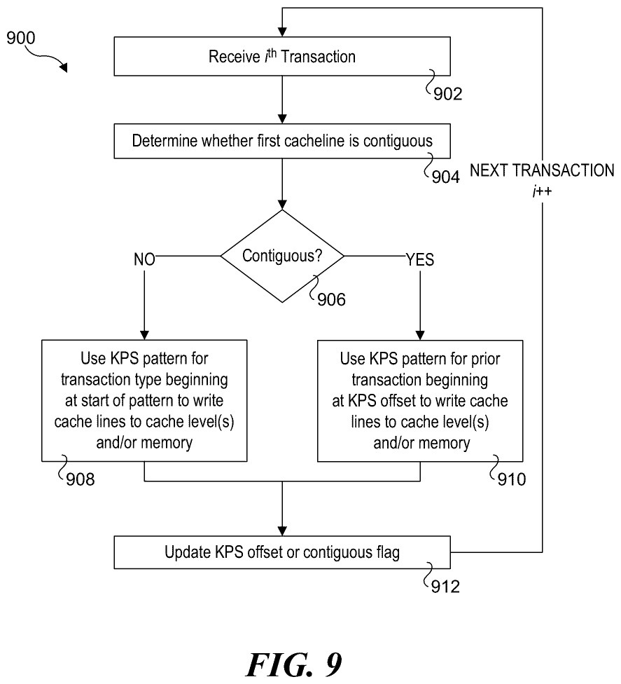

FIG. 9 shows a flowchart 900 illustrating operations and logic implemented by a PDL instance, according to one embodiment. In a block 902 an i^{th} transaction is received. In a block 904 a determine is made to whether the first cacheline of the i^{th} transaction is contiguous with the immediately preceding transaction. As depicted by a decision block 906, if the cacheline is not contiguous the answer is NO and the transaction contains a new packet, message, or other data unit. Accordingly, the logic proceeds to a block 908 in which the KPS pattern for the transaction type beginning at the start of the pattern is used to write cache lines to the cache level(s) and/or memory specified by the values encoded in the KPS pattern. If the answer to decision block 906 is YES, indicating the first cacheline is contiguous with the last cacheline of the prior transaction payload data, the logic to proceeds to a block 910. In this case, rather than beginning at the start of the KPS pattern, the KPS offset register is used to continue using the KPS pattern where the prior transaction left off. The KPS pattern values beginning at that location are then used to write cache lines in the transaction payload data to the applicable cache level(s) and/or memory.

Following the operations of block 908 or 910, the logic proceeds to a block 912 in which the KPS offset is updated, or the contiguous flag is set. The KPS offset can be updated following payload data being written for a given transaction, or it may be advanced by one as each cacheline is written. The logic then increments the transaction count i by one and returns to block 902 to process the next transaction.

In one embodiment the data bus going from PDL to the CPU or coherent interconnect contains an additional bit or bits (called Key Line Bit(S) (KLB(s))) per cache line. For a single-bit KPS, a KLB is set to ‘1’ for a key cache line and to ‘0’ for unimportant cache lines based on the bit position in the KPS pattern. For multi-bit KPS patterns, multiple KLBs are used. For example, the two-bit KPS pattern encoding scheme in FIG. 6(B) would use two KLBs per cache line. In one embodiment, the data bus going from the PDL to the IIO will contain one or more additional bits.

Under an alternative embodiment, a message may be sent in advance of the cache line transfers for a given transaction to the IIO or to a cache agent, such as the LLC agent or an agent associated with the global queue for processors or SoCs implementing an architecture similar to that shown in FIG. 4. Each cacheline from an IO port will be written or copied to the global queue prior to being written to any cache level or memory. The LLC agent can monitor the global queue for writes from the IIO and determine where the cache lines are to be written.

Under yet another embodiment, the cache lines themselves may include one or more extra bits encoded with the KPS bit or bits associated with individual cache lines. For example, 64B cache lines (or other size cache line) will be prepended with additional status bits that are used for effecting a cache coherency protocol and (optionally) for additional purposes. This scheme could further be combined with the core ID bits such that each cache line could include core ID bits+KPS bit(s)+cache line data. An example of this approach is illustrated in FIG. 10, where the cache line data 1000 are prepended with a core ID 1002 and KPS bits 1004.

For embodiments that do not employ core IDs, the core associates with a destination (to be written to) L1 or L2 cache may be identified using the snoop filter(s) maintained by the cache agents. For example, the cache agents for the different caches may employ a snoop filter that is used to determine whether a given cache line is present in that cache. Cache line snooping schemes are well-known in the art, as are the snoop filter designs, with the particular snooping scheme and snoop filter design to be implemented being outside the scope of this disclosure.

Generally, a cache agent (such as an L3 or LLC agent) can check the cache line address and perform a snoop to see if the cache line is present in the L3 cache or LLC. It can also broadcast snoop messages to the L1 and L2 caches. Since each cache line containing data originating at an IO port may be a new cache line that includes data relating to a previously-written cache line the snoop may involve snooping for a previously-written cache line using the address of that cache line. For a snoop ‘hit,’ the identity of the cache containing the previously-written cache line will be identified, and the new cache line will be written to that cache if the KPS bit or bits indicate the level of the cache is applicable. For cache lines that are destined for the L3 or LLC or memory, the cache line will be written to L3/LLC or memory without performing any snooping.

In addition to implementation on platforms CPUs, the teaching and principles disclosed herein may be applied to Other Processing Units (collectively termed XPUs) including one or more of Graphic Processor Units (GPUs) or General Purpose GPUs (GP-GPUs), Tensor Processing Units (TPUs), Data Processing Units (DPUs), Infrastructure Processing Units (IPUs), Artificial Intelligence (AI) processors or AI inference units and/or other accelerators, Network Interface Controllers (NICs) and SmartNICs, FPGAs and/or other programmable logic (used for compute purposes), etc. While some of the diagrams herein show the use of CPUs, this is merely exemplary and non-limiting. Generally, any type of XPU having one or more IO ports, processing elements, and a cache architecture may be used in place of a CPU in the illustrated embodiments. Moreover, as used in the following claims, the term “processor” is used to generically cover CPUs and various forms of XPUs and SoCs.

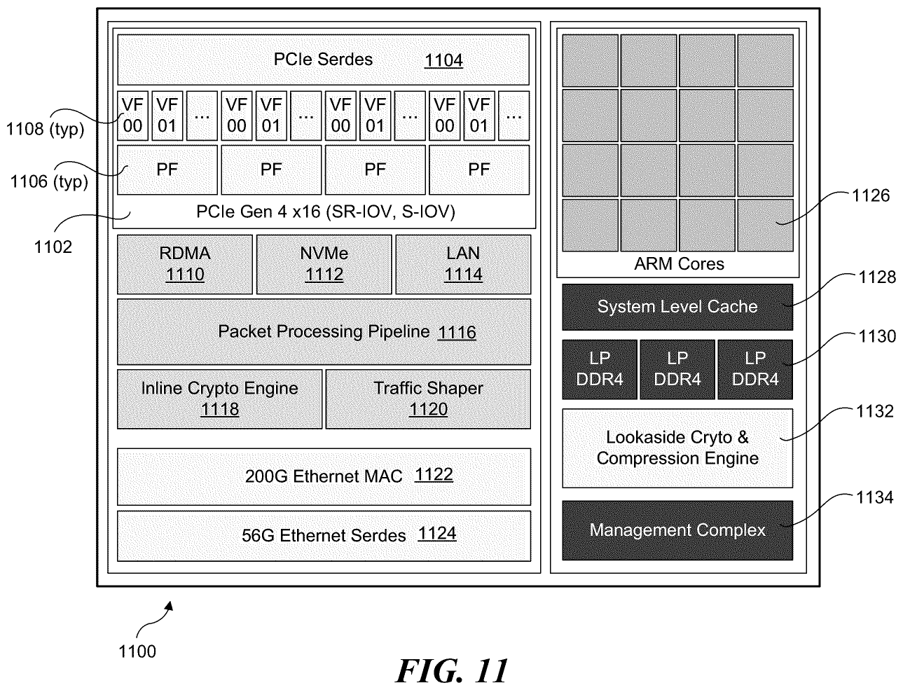

FIG. 11 shows an exemplary IPU chip 1100 that may be installed on a main board of a compute platform or may be included on a daughterboard or an expansion card, such as but not limited to a PCIe card. IPU chip 1100 includes a 4^{th} generation PCIe interface 1102 including 16 lanes. The PCIe PHY operations for PCIe interface 1102 include a PCIe Serdes (Serializer/Deserializer) block 1104.

In the illustrated embodiment, PCIe interface 1102 supports SR-My (Single Root-I/O Virtualization) and S-IOV (Scalable I/O Virtualization). SR-IOV and S-IOV are facilitated by Physical Functions (PFs) 1106 and Virtual Functions 1108 that are implemented in accordance with SR-IOV and S-IOV specifications.

Next, IPU chip 1100 includes a set of IP blocks, as depicted by an RDMA block 1110, an NVMe block 1112, a LAN (Local Area Network) block 1114, a packet processing pipeline 1116, and inline cryptographic engine 1118, and a traffic shaper 1120.

IPU chip 1100 includes various circuitry for implementing one or more Ethernet interfaces, including a 200 Gigabits/second (G) Ethernet MAC block 1122 and a 56G Ethernet Serdes block 1124. Generally, the MAC and Ethernet Serdes resources in 200G Ethernet MAC block 1122 and 56G Ethernet Serdes block 1124 may be split between multiple Ethernet ports, under which each Ethernet port will be configured to support a standard Ethernet bandwidth and associated Ethernet protocol.

As shown in the upper right corner, IPU chip 1110 includes multiple ARM cores 1126 employing an ARM architecture. The ARM cores are used for executing various software components and application that may run on IPU chip 1100. ARM cores 1126 are coupled to a system level cache block 1128 which is used to cache memory accessed from one or more memory devices 1130. In this non-limiting example, the memory devices are LP DDR4 memory devices. More generally, an existing or future memory standard may be used, including those described below.

The last two IP blocks for IPU chip 1100 include a lookaside cryptographic and compression engine 1132 and a management complex 1134. Lookaside cryptographic and compression engine 1132 supports cryptographic (encryption/description) and compression/decompression operations that are offloaded from ARM cores 1126. Management complex 1134 comprises logic for implementing various management functions and operations.

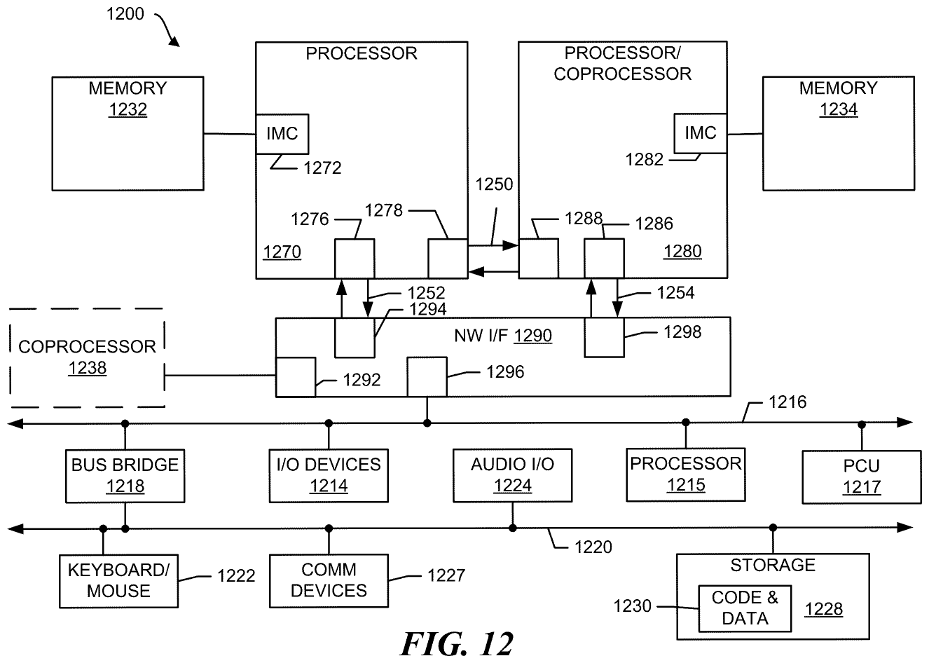

FIG. 12 illustrates an example computing system. Multiprocessor system 1200 is an interfaced system and includes a plurality of processors or cores including a first processor 1270 and a second processor 1280 coupled via an interface 1250 such as a point-to-point (P-P) interconnect, a fabric, and/or bus. In some examples, the first processor 1270 and the second processor 1280 are homogeneous. In some examples, first processor 1270 and the second processor 1280 are heterogenous. Though the example system 1200 is shown to have two processors, the system may have three or more processors, or may be a single processor system. In some examples, the computing system is a system on a chip (SoC).

Processors 1270 and 1280 are shown including integrated memory controller (IMC) circuitry 1272 and 1282, respectively. Processor 1270 also includes interface circuits 1276 and 1278; similarly, second processor 1280 includes interface circuits 1286 and 1288. Processors 1270, 1280 may exchange information via the interface 1250 using interface circuits 1278, 1288. IMCs 1272 and 1282 couple the processors 1270, 1280 to respective memories, namely a memory 1232 and a memory 1234, which may be portions of main memory locally attached to the respective processors.

Processors 1270, 1280 may each exchange information with a network interface (NW I/F) 1290 via individual interfaces 1252, 1254 using interface circuits 1276, 1294, 1286, 1298. The network interface 1290 (e.g., one or more of an interconnect, bus, and/or fabric, and in some examples is a chipset) may optionally exchange information with a coprocessor 1238 via an interface circuit 1292. In some examples, the coprocessor 1238 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1270, 1280 or outside of both processors, yet connected with the processors via an interface such as P-P interconnect, such that either or both processors' local cache information may be stored in the shared cache if a processor is placed into a low power mode.

Network interface 1290 may be coupled to a first interface 1216 via interface circuit 1296. In some examples, first interface 1216 may be an interface such as a Peripheral Component Interconnect (PCI) interconnect, a PCI Express interconnect or another I/O interconnect. In some examples, first interface 1216 is coupled to a power control unit (PCU) 1217, which may include circuitry, software, and/or firmware to perform power management operations with regard to the processors 1270, 1280 and/or co-processor 1238. PCU 1217 provides control information to a voltage regulator (not shown) to cause the voltage regulator to generate the appropriate regulated voltage. PCU 1217 also provides control information to control the operating voltage generated. In various examples, PCU 1217 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1217 is illustrated as being present as logic separate from the processor 1270 and/or processor 1280. In other cases, PCU 1217 may execute on a given one or more of cores (not shown) of processor 1270 or 1280. In some cases, PCU 1217 may be implemented as a microcontroller (dedicated or general-purpose) or other control logic configured to execute its own dedicated power management code, sometimes referred to as P-code. In yet other examples, power management operations to be performed by PCU 1217 may be implemented externally to a processor, such as by way of a separate power management integrated circuit (PMIC) or another component external to the processor. In yet other examples, power management operations to be performed by PCU 1217 may be implemented within BIOS or other system software.

Various I/O devices 1214 may be coupled to first interface 1216, along with a bus bridge 1218 which couples first interface 1216 to a second interface 1220. In some examples, one or more additional processor(s) 1215, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1216. In some examples, second interface 1220 may be a low pin count (LPC) interface. Various devices may be coupled to second interface 1220 including, for example, a keyboard and/or mouse 1222, communication devices 1227 and storage circuitry 1228. Storage circuitry 1228 may be one or more non-transitory machine-readable storage media as described below, such as a disk drive or other mass storage device which may include instructions/code and data 1230. Further, an audio I/O 1224 may be coupled to second interface 1220. Note that other architectures than the point-to-point architecture described above are possible. For example, instead of the point-to-point architecture, a system such as multiprocessor system 1200 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

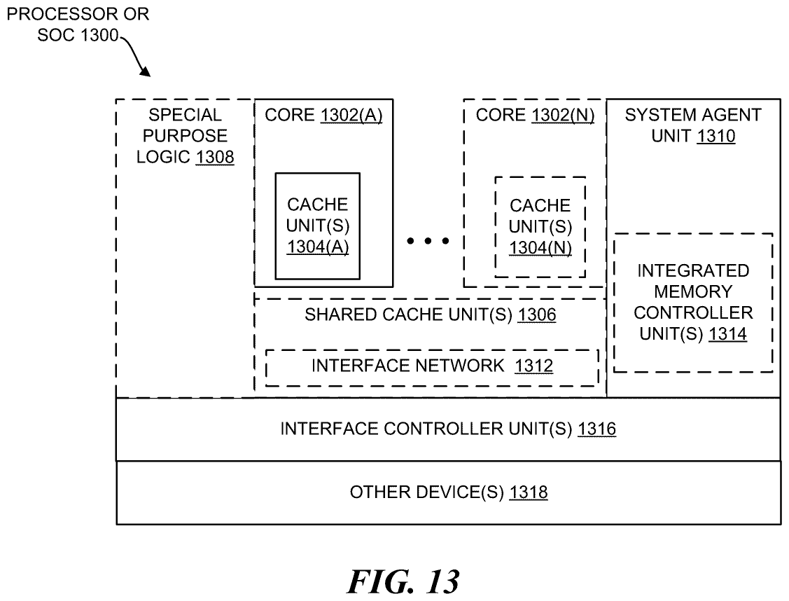

FIG. 13 illustrates a block diagram of an example processor and/or SoC 1300 that may have one or more cores and an integrated memory controller. The solid lined boxes illustrate a processor 1300 with a single core 1302(A), system agent unit circuitry 1310, and a set of one or more interface controller unit(s) circuitry 1316, while the optional addition of the dashed lined boxes illustrates an alternative processor 1300 with multiple cores 1302(A)-(N), a set of one or more integrated memory controller unit(s) circuitry 1314 in the system agent unit circuitry 1310, and special purpose logic 1308, as well as a set of one or more interface controller units circuitry 1316. Note that the processor 1300 may be one of the processors 1270 or 1280, or co-processor 1238 or 1215 of FIG. 12.

Thus, different implementations of the processor 1300 may include: 1) a CPU with the special purpose logic 1308 being integrated graphics and/or scientific (throughput) logic (which may include one or more cores, not shown), and the cores 1302(A)-(N) being one or more general purpose cores (e.g., general purpose in-order cores, general purpose out-of-order cores, or a combination of the two); 2) a coprocessor with the cores 1302(A)-(N) being a large number of special purpose cores intended primarily for graphics and/or scientific (throughput); and 3) a coprocessor with the cores 1302(A)-(N) being a large number of general purpose in-order cores. Thus, the processor 1300 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1304(A)-(N) within the cores 1302(A)-(N), a set of one or more shared cache unit(s) circuitry 1306, and external memory (not shown) coupled to the set of integrated memory controller unit(s) circuitry 1314. The set of one or more shared cache unit(s) circuitry 1306 may include one or more mid-level caches, such as level 2 (L2), level 3 (L3), level 4 (L4), or other levels of cache, such as a last level cache (LLC), and/or combinations thereof. While in some examples interface network circuitry 1312 (e.g., a ring interconnect) interfaces the special purpose logic 1308 (e.g., integrated graphics logic), the set of shared cache unit(s) circuitry 1306, and the system agent unit circuitry 1310, alternative examples use any number of well-known techniques for interfacing such units. In some examples, coherency is maintained between one or more of the shared cache unit(s) circuitry 1306 and cores 1302(A)-(N). In some examples, interface controller units circuitry 1316 couple the cores 1302 to one or more other devices 1318 such as one or more I/O devices, storage, one or more communication devices (e.g., wireless networking, wired networking, etc.), etc.

In some examples, one or more of the cores 1302(A)-(N) are capable of multi-threading. The system agent unit circuitry 1310 includes those components coordinating and operating cores 1302(A)-(N). The system agent unit circuitry 1310 may include, for example, power control unit (PCU) circuitry and/or display unit circuitry (not shown). The PCU may be or may include logic and components needed for regulating the power state of the cores 1302(A)-(N) and/or the special purpose logic 1308 (e.g., integrated graphics logic). The display unit circuitry is for driving one or more externally connected displays.

The cores 1302(A)-(N) may be homogenous in terms of instruction set architecture (ISA). Alternatively, the cores 1302(A)-(N) may be heterogeneous in terms of ISA; that is, a subset of the cores 1302(A)-(N) may be capable of executing an ISA, while other cores may be capable of executing only a subset of that ISA or another ISA.

### Example Core Architectures—In-Order and Out-of-Order Core Block Diagram

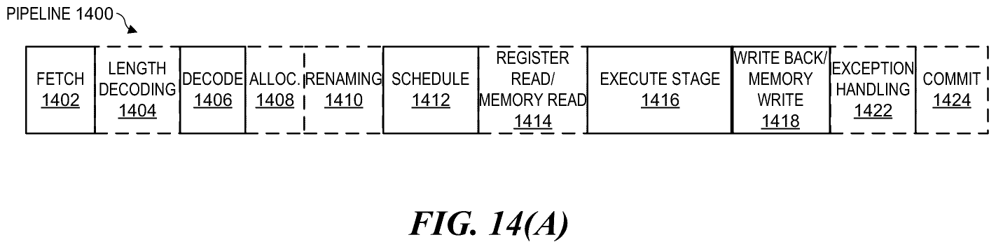

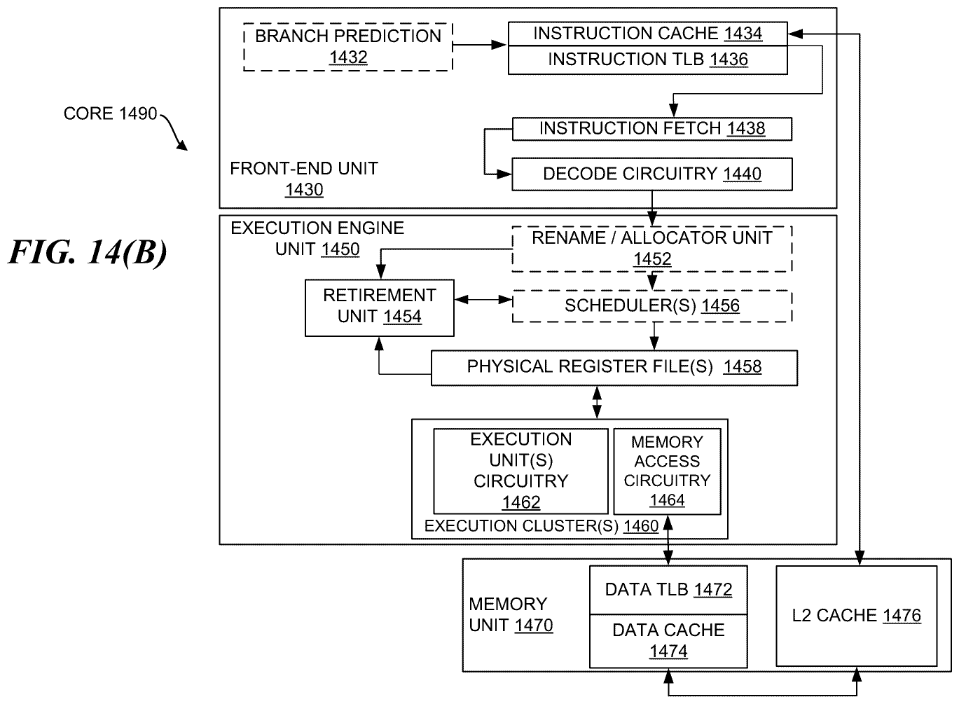

FIG. 14(A) is a block diagram illustrating both an example in-order pipeline and an example register renaming, out-of-order issue/execution pipeline according to examples. FIG. 14(B) is a block diagram illustrating both an example in-order architecture core and an example register renaming, out-of-order issue/execution architecture core to be included in a processor according to examples. The solid lined boxes in FIGS. 14(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 14(A), a processor pipeline 1400 includes a fetch stage 1402, an optional length decoding stage 1404, a decode stage 1406, an optional allocation (Alloc) stage 1408, an optional renaming stage 1410, a schedule (also known as a dispatch or issue) stage 1412, an optional register read/memory read stage 1414, an execute stage 1416, a write back/memory write stage 1418, an optional exception handling stage 1422, and an optional commit stage 1424. One or more operations can be performed in each of these processor pipeline stages. For example, during the fetch stage 1402, one or more instructions are fetched from instruction memory, and during the decode stage 1406, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1406 and the register read/memory read stage 1414 may be combined into one pipeline stage. In one example, during the execute stage 1416, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 14(B) may implement the pipeline 1400 as follows: 1) the instruction fetch circuitry 1438 performs the fetch and length decoding stages 1402 and 1404; 2) the decode circuitry 1440 performs the decode stage 1406; 3) the rename/allocator unit circuitry 1452 performs the allocation stage 1408 and renaming stage 1410; 4) the scheduler(s) circuitry 1456 performs the schedule stage 1412; 5) the physical register file(s) circuitry 1458 and the memory unit circuitry 1470 perform the register read/memory read stage 1414; the execution cluster(s) 1460 perform the execute stage 1416; 6) the memory unit circuitry 1470 and the physical register file(s) circuitry 1458 perform the write back/memory write stage 1418; 7) various circuitry may be involved in the exception handling stage 1422; and 8) the retirement unit circuitry 1454 and the physical register file(s) circuitry 1458 perform the commit stage 1424.

FIG. 14(B) shows a processor core 1490 including front-end unit circuitry 1430 coupled to execution engine unit circuitry 1450, and both are coupled to memory unit circuitry 1470. The core 1490 may be a reduced instruction set architecture computing (RISC) core, a complex instruction set architecture computing (CISC) core, a very long instruction word (VLIW) core, or a hybrid or alternative core type. As yet another option, the core 1490 may be a special-purpose core, such as, for example, a network or communication core, compression engine, coprocessor core, general purpose computing graphics processing unit (GPGPU) core, graphics core, or the like.

The front-end unit circuitry 1430 may include branch prediction circuitry 1432 coupled to instruction cache circuitry 1434, which is coupled to an instruction translation lookaside buffer (TLB) 1436, which is coupled to instruction fetch circuitry 1438, which is coupled to decode circuitry 1440. In one example, the instruction cache circuitry 1434 is included in the memory unit circuitry 1470 rather than the front-end circuitry 1430. The decode circuitry 1440 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1440 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1440 may be implemented using various different mechanisms. Examples of suitable mechanisms include, but are not limited to, look-up tables, hardware implementations, programmable logic arrays (PLAs), microcode read only memories (ROMs), etc. In one example, the core 1490 includes a microcode ROM (not shown) or other medium that stores microcode for certain macroinstructions (e.g., in decode circuitry 1440 or otherwise within the front-end circuitry 1430). In one example, the decode circuitry 1440 includes a micro-operation (micro-op) or operation cache (not shown) to hold/cache decoded operations, micro-tags, or micro-operations generated during the decode or other stages of the processor pipeline 1400. The decode circuitry 1440 may be coupled to rename/allocator unit circuitry 1452 in the execution engine circuitry 1450.

The execution engine circuitry 1450 includes the rename/allocator unit circuitry 1452 coupled to retirement unit circuitry 1454 and a set of one or more scheduler(s) circuitry 1456. The scheduler(s) circuitry 1456 represents any number of different schedulers, including reservations stations, central instruction window, etc. In some examples, the scheduler(s) circuitry 1456 can include arithmetic logic unit (ALU) scheduler/scheduling circuitry, ALU queues, address generation unit (AGU) scheduler/scheduling circuitry, AGU queues, etc. The scheduler(s) circuitry 1456 is coupled to the physical register file(s) circuitry 1458. Each of the physical register file(s) circuitry 1458 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1458 includes vector registers unit circuitry, writemask registers unit circuitry, and scalar register unit circuitry. These register units may provide architectural vector registers, vector mask registers, general-purpose registers, etc. The physical register file(s) circuitry 1458 is coupled to the retirement unit circuitry 1454 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1454 and the physical register file(s) circuitry 1458 are coupled to the execution cluster(s) 1460. The execution cluster(s) 1460 includes a set of one or more execution unit(s) circuitry 1462 and a set of one or more memory access circuitry 1464. The execution unit(s) circuitry 1462 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1456, physical register file(s) circuitry 1458, and execution cluster(s) 1460 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1464). It should also be understood that where separate pipelines are used, one or more of these pipelines may be out-of-order issue/execution and the rest in-order.

In some examples, the execution engine unit circuitry 1450 may perform load store unit (LSU) address/data pipelining to an Advanced Microcontroller Bus (AMB) interface (not shown), and address phase and writeback, data phase load, store, and branches.

The set of memory access circuitry 1464 is coupled to the memory unit circuitry 1470, which includes data TLB circuitry 1472 coupled to data cache circuitry 1474 coupled to level 2 (L2) cache circuitry 1476. In one example, the memory access circuitry 1464 may include load unit circuitry, store address unit circuitry, and store data unit circuitry, each of which is coupled to the data TLB circuitry 1472 in the memory unit circuitry 1470. The instruction cache circuitry 1434 is further coupled to the level 2 (L2) cache circuitry 1476 in the memory unit circuitry 1470. In one example, the instruction cache 1434 and the data cache 1474 are combined into a single instruction and data cache (not shown) in L2 cache circuitry 1476, level 3 (L3) cache circuitry (not shown), and/or main memory. The L2 cache circuitry 1476 is coupled to one or more other levels of cache and eventually to a main memory.

The core 1490 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1490 includes logic to support a packed data instruction set architecture extension (e.g., AVX1, AVX2), thereby allowing the operations used by many multimedia applications to be performed using packed data.

### Example Execution Unit(s) Circuitry

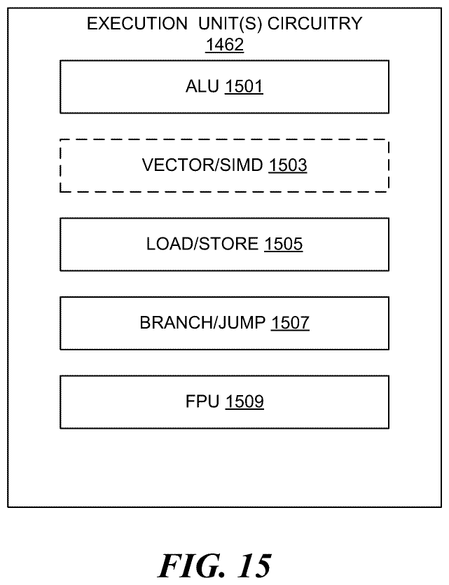

FIG. 15 illustrates examples of execution unit(s) circuitry, such as execution unit(s) circuitry 1462 of FIG. 14(B). As illustrated, execution unit(s) circuitry 1462 may include one or more ALU circuits 1501, optional vector/single instruction multiple data (SIMD) circuits 1503, load/store circuits 1505, branch/jump circuits 1507, and/or Floating-point unit (FPU) circuits 1509. ALU circuits 1501 perform integer arithmetic and/or Boolean operations. Vector/SIMD circuits 1503 perform vector/SIMD operations on packed data (such as SIMD/vector registers). Load/store circuits 1505 execute load and store instructions to load data from memory into registers or store from registers to memory. Load/store circuits 1505 may also generate addresses. Branch/jump circuits 1507 cause a branch or jump to a memory address depending on the instruction. FPU circuits 1509 perform floating-point arithmetic. The width of the execution unit(s) circuitry 1462 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

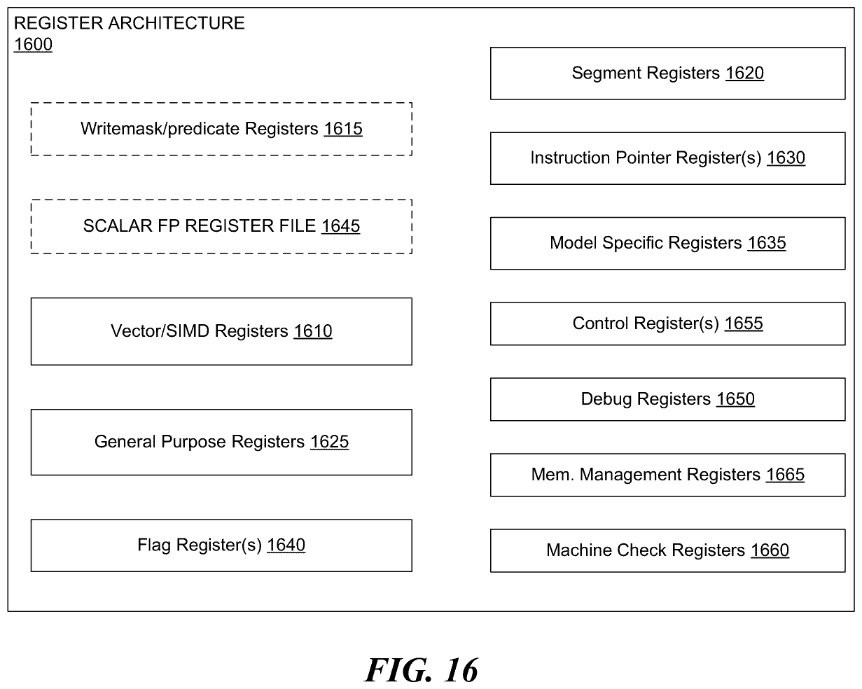

FIG. 16 is a block diagram of a register architecture 1600 according to some examples. As illustrated, the register architecture 1600 includes vector/SIMD registers 1610 that vary from 128-bit to 1,024 bits width. In some examples, the vector/SIMD registers 1610 are physically 512-bits and, depending upon the mapping, only some of the lower bits are used. For example, in some examples, the vector/SIMD registers 1610 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1600 includes writemask/predicate registers 1615. For example, in some examples, there are 8 writemask/predicate registers (sometimes called k0 through k7) that are each 16-bit, 32-bit, 64-bit, or 128-bit in size. Writemask/predicate registers 1615 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1615 corresponds to a data element position of the destination. In other examples, the writemask/predicate registers 1615 are scalable and consists of a set number of enable bits for a given vector element (e.g., 8 enable bits per 64-bit vector element).

The register architecture 1600 includes a plurality of general-purpose registers 1625. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1600 includes scalar floating-point (FP) register file 1645 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1640 (e.g., EFLAGS, RFLAGS, etc.) store status and control information for arithmetic, compare, and system operations. For example, the one or more flag registers 1640 may store condition code information such as carry, parity, auxiliary carry, zero, sign, and overflow. In some examples, the one or more flag registers 1640 are called program status and control registers.

Segment registers 1620 contain segment points for use in accessing memory. In some examples, these registers are referenced by the names CS, DS, SS, ES, FS, and GS.

Model specific registers (MSRs) 1635 are a type of control register that control and report on processor performance for a given processor model or family. Most MSRs 1635 handle system-related functions and are not accessible to an application program. Machine check registers 1660 consist of control, status, and error reporting MSRs that are used to detect and report on hardware errors.

One or more instruction pointer register(s) 1630 store an instruction pointer value. Control register(s) 1655 (e.g., CR0-CR4) determine the operating mode of a processor (e.g., processor 1270, 1280, 1238, 1215, and/or 1300) and the characteristics of a currently executing task. Debug registers 1650 control and allow for the monitoring of a processor or core's debugging operations.

Memory (mem) management registers 1665 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1600 may, for example, be used in a register file/memory, or physical register file(s) circuitry 1458.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software or firmware running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A processor, comprising:
a plurality of processing elements;
a cache domain including a plurality of caches in which cache lines are to be stored;
an input-output (IO) port, operatively coupled to the cache domain; and
circuitry and logic to,
logically partition a data unit received at the IO port into a plurality of cache lines; and
identify one or more cache lines among the plurality of cache lines that are important; and
write, for each cache line identified as important, the cache line to a cache in the cache domain.

2. The processor of claim 1, wherein the data unit is contained in a Peripheral Component Interconnect Express (PCIe) transaction.

3. The processor of claim 1, wherein the data unit is contained in a memory transaction including a memory cache line address.

4. The processor of claim 1, wherein the circuitry and logic include a register that is configured to be programmed by software executing on one or more of the plurality of processing elements to identify cache lines in a data unit of a given type of data unit are important.

5. The processor of claim 1, further comprising circuitry and logic to detect whether a unit of data received from the IO is part of a previous packet or a new packet.

6. The processor of claim 5, further comprising a packet address (PA) register to store a cache line address, wherein the circuitry and logic is further configured to:
store an address for a last cache line that is forwarded to the CPU coherent domain;
detect a new transaction include a data payload has been received from the IO device, the new transaction including a cache line address;
compare the cache line address with the cache line address stored in the PA to determine whether the cache line address for the new transaction and the cache line address in the PA are contiguous; and
when the cache line address for the new transaction and the cache line address in the PA are contiguous, detecting the unit of data is part of a previous packet.

7. The processor of claim 1, wherein the cache domain comprises a coherent cache domain including a plurality of Level 1 (L1) and Level 2 (L2) caches and a Level 3 (L3) or Last Level Cache (LLC).

8. The processor of claim 1, wherein the IO port comprises one of a Peripheral Component Interconnect Express (PCIe) IO port, a Compute Express Link (CXL) IO port, and a Non-volatile Memory Express (NVMe) IO port.

9. The processor of claim 1, wherein the IO port comprises an Advanced High performance Bus (AHB), an Advanced Xtensible Bus (AXI), and a Universal Serial Bus (USB) IO port.

10. The processor of claim 1, wherein the one or more cache lines among the plurality of cache lines that are important comprise key sections of the data unit.

11. A method implemented on a processor including a plurality of cores and a cache domain having multiple caches to which an input-output (IO) port is operationally coupled, and a memory controller coupled to memory, the method comprising:
receiving a transaction at the IO port including a transaction address and data;
logically partitioning the data into a plurality of cache lines;
identify one or more important cache lines among the plurality of cache lines, the one or more important cache lines corresponding to key segments of the data; and
writing, for each of the cache lines identified as important, the cache line to a cache in the cache domain.

12. The method of claim 11, further comprising writing non-important cache lines among the plurality of cache lines to memory.

13. The method of claim 11, wherein the important cache lines are written to a cache having a first level, further comprising writing non-important cache lines among the plurality of cache lines to a cache having a second level higher than the first level.

14. The method of claim 11, further comprising:
enabling software executing on a core to program a register to identify an importance pattern of cache lines in an associated data structure; and
using the importance pattern to identify important cache lines in a received transaction.

15. The method of claim 11, further comprising:
receiving a first transaction containing a complete packet or a first portion of a packet;
receiving a second transaction containing a new packet or a second portion of a packet; and
detecting whether the second transaction contains a new packet or a second portion of a packet.

16. The method of claim 15, further comprising:
for the first transaction, storing a cache line address of a last cache line;
comparing a first cache line address for data contained in the second transaction with the cache line address that is stored to determine whether the cache lines are contiguous; and
when the cache lines are determined to not be contiguous, detecting the second transaction contains a new packet.

17. The method of claim 11, further comprising:
determining a core that will be used to consume the data; and
writing important cache lines to a local cache associated with the core that is determined.

18. A computing system comprising:
memory, configured to store a plurality of cache lines;
an input-output (IO) device; and
a processor, operatively coupled to the memory, including,
a plurality of processing elements;
a cache domain including a plurality of caches in which cache lines are stored;
an input-output (IO) port, operatively coupled to the cache domain and to which the IO device is coupled; and
circuitry and logic to,
logically partition a data unit received from an IO device coupled to the IO port into a plurality of cache lines; and
identify one or more cache lines among the plurality of cache lines that comprise one or more key sections of the data unit are important; and
write, for each cache line identified as important, the cache line to a cache in the cache domain.

19. The computing system of claim 18, further comprising:
software instructions loaded into the memory or stored in a storage device operationally coupled to the processor,
wherein execution of the software instructions on a core programs a register to identify an importance pattern of cache lines in an associated data structure, and wherein the importance pattern is used to identify important cache lines in a received transaction.

20. The computing system of claim 18, wherein the processor further comprises circuitry and logic to detect whether a unit of data received from the IO is part of a previous packet or a new packet.

21. The computing system of claim 18, wherein the IO port comprises a Peripheral Component Interconnect Express (PCIe) IO port, the IO device comprises a PCIe device and wherein the data unit is received in a PCIe transaction.
